(19) United States
(12) Patent Application Publication
(10) Pub. No.: US 2023/0064571 A1
(43) Pub. Date: Mar. 2, 2023

(54) NIBS FOR STYLUSES

(71) Applicant: HEWLETT-PACKARD DEVELOPMENT COMPANY, L.P., Spring, TX (US)

(72) Inventors: Shih-Jen Chang, Taipei City (TW); Jyun-Cheng Lin, Taipei City (TW); Cheng-Hua Yu, Taipei City (TW); Hogan Hote Yeh, Taipei City (TW)

(73) Assignee: HEWLETT-PACKARD DEVELOPMENT COMPANY, L.P., Spring, TX (US)

(21) Appl. No.: 17/796,727

(22) PCT Filed: Jan. 31, 2020
(86) PCT No.: PCT/US2020/016227

§ 371 Date: Aug. 1, 2022

(51) Int. Cl. G06F 3/0354

(52) U.S. Cl. CPC G06F 3/03545

(57) ABSTRACT

Examples of nibs for styluses are described. In an example, the nib is made of a base material (for example, a polyamide or a polycarbonate), a conductive material (for example, carbon fiber), and a grey color controlling material (for example, a white powder). The base material is in a range of 70 weight percentage (wt %) to 75 wt %. The conductive material is in a range of 15 wt % to 20 wt %. The grey color controlling material in a range of 5 wt % to 10 wt %.

### BACKGROUND

Styluses are pointing devices used with touch-sensitive display devices, such as smart phones, portable digital assistants, and tablet-style computers. Such a stylus may include a nib made of a conductive material, for example carbon fiber. The stylus, when the conductive nib is touched with a touch-sensitive surface of a touch-sensitive display device, transmits a stimulus signal to prompt the touch-sensitive display device to register the touch.

### BRIEF DESCRIPTION OF FIGURES

The detailed description is provided with reference to the accompanying figures, wherein:

FIG. 1 illustrates a sectional view of a nib, according to an example;

FIG. 2 illustrates a sectional view of a stylus having a nib, according to an example;

FIG. 3 illustrates a schematic view of a stylus having a nib, according to an example; and

FIG. 4 illustrates a sectional view of a stylus having a nib, according to an example.

### DETAILED DESCRIPTION

Nibs of styluses may be made of carbon fiber to obtain touch-sensitive performance with respect to touch-sensitive display devices. The carbon fiber is an expensive material and, thus, the cost of such nibs is higher as compared to nibs made of non-conductive materials. Further, the nibs made of the carbon fiber are black in color due to the color of the carbon fiber.

In some styluses, the nibs made of carbon fiber may be painted with a conductive material having a color other than black. The painting of the nib is an additional process which increases the cost of the nib, thereby increasing the overall cost of the stylus.

Further, a painted nib may abrade after a certain period of usage, which may take off the paint from the nib thereby making the nib blunt. The abraded nib is aesthetically unappealing, and the blunt nib shows performance issues. Thus, the nib or the stylus may have to be replaced frequently, which adds to the cost to users.

The present subject matter describes example nibs for styluses, for example active styluses. The nibs of the present subject matter are soft, conductive, and grey in color. The nib is soft so as to enable reuse of the nib when it abrades after a certain period of usage. The nib is conductive so as to work efficiently by obtaining touch-sensitive performance with respect to touch-sensitive display devices. The grey color of the nib is aesthetically pleasing as compared to black colored nibs. In an example, the grey color of the nib may match with the color of the stylus, thereby making the stylus aesthetically pleasing. Such a nib of the present subject matter, which is soft, conductive, and grey in color, can be obtained cost effectively.

In an example, the nib is made of a composition of one of a polyamide and a polycarbonate, carbon fiber, and a white powder. The polyamide or the polycarbonate is in a range of 70 weight percentage (wt %) to 75 wt %. The term “weight percentage”, or “wt %”, of a component used herein refers to a percentage weight of that component relative to 100% weight of the composition. Use of the polyamide or the polycarbonate makes the nib soft while ensuring strength of the nib. The soft nib safeguards a touch-sensitive display device from damage, which may occur when the nib of a stylus is touched to a display of the touch-sensitive display device during operation of the stylus. Further, in the composition of the nib, the carbon fiber is in a range of 15 wt % to 20 wt %.

Furthermore, in the composition of the nib, the white powder is in a range of 5 wt % to 10 wt %. In one example, the white powder is nylon. The white powder makes the nib grey in color when combined with the carbon fiber of black color. The white powder may be varied from 5 wt % to 10 wt % to control the color of the nib between light grey and dark grey and provides a variety of grey color options of the nib to users of the stylus. The composition of the materials of the nibs, in accordance with the present subject matter, makes the nibs cost-effective in comparison to nibs having a higher wt % of carbon fiber, without affecting the performance with respect to touch-sensitive surfaces.

Further, in an example, the nib of the stylus is made through-and-through of the composition of one of the polyamide and the polycarbonate, the carbon fiber, and the white powder. When the stylus is in operation, the nib is touched with a touch-sensitive surface of the touch-sensitive display device. The stylus then transmits a stimulus signal to prompt the touch-sensitive display device to register the touch. The nib may abrade after a period of usage of the stylus. The abraded nib remains grey in color even after abrasion and thus the abrasion of the nib does not affect the aesthetic appeal of the nib.

The following detailed description refers to the accompanying drawings. Wherever possible, the same reference numbers are used in the drawings and the following description to refer to the same or similar parts. While several examples are described in the description, modifications, adaptations, and other implementations are possible. Accordingly, the following detailed description does not limit the disclosed examples. Instead, the proper scope of the disclosed examples may be defined by the appended claims.

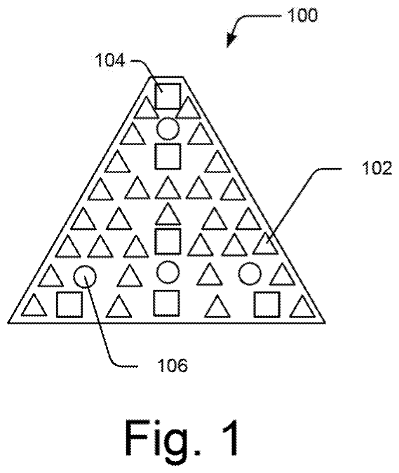

FIG. 1 illustrates a sectional view of a nib 100, according to an example. The nib 100 is a component of a stylus (not shown in FIG. 1) that touches a touch-sensitive surface (not shown) of a touch-sensitive display device (not shown). In an example, the stylus may be an active stylus. In an example, the nib 100 may be frusto-conical in shape. In an example, shape of the nib 100 may be conical, rounded or semi-spherical. As shown, the nib 100 is made of a composition including one of a polycarbonate or a polyamide in a range of 70 weight percentage (wt %) to 75 wt %. The polycarbonate or the polyamide in the nib 100 is indicated by triangles in FIG. 1 and referenced as 102. The reference numeral 102 may be interchangeably used to refer to the polycarbonate or the polyamide. Polycarbonate is a synthetic thermoplastic used for molding of products, such as nibs. Polyamide is a synthetic fiber used for molding of products, such as nibs. Use of either of the polycarbonate 102 and the polyamide 102 makes the nib 100 softer in comparison to nibs exclusively made of carbon fiber. Soft nibs can be reshaped to attain a pointier shape of the nib 100 for reuse when the nib 100 abrades after a period of usage.

The composition further includes carbon fiber in a range of 15 wt % to 20 wt % and a white powder in a range of 5 wt % to 10 wt %. The carbon fiber is indicated by squares in FIG. 1 and referenced as 104. The carbon fiber 104 is a conductive material, which makes the nib 100 of the stylus conductive. The conductive nib 100 obtains optimum touch-sensitive performance with respect to the touch-sensitive display device. The nib 100 is not exclusively made of carbon fiber 104. Thus, the cost of the nib 100 with the carbon fiber 104 in a range of 15 wt % to 20 wt % is less as compared to nibs exclusively made of conductive materials. Further, the white powder is indicated by circles in FIG. 1 and referenced as 106. The white powder 106 is a material that contributes to controlling of the color of the nib 100. The presence of the white powder 106 in the composition makes the nib 100 of the stylus grey in color. The white powder 106 can be varied within the range of wt %, as mentioned herein, to control the color of the nib 100 between light grey and dark grey.

In an example, the composition may include the polycarbonate 102, the carbon fiber 104 and the white powder 106. In an example, the nib 100 may have 70 wt % of the polycarbonate 102, 20 wt % of the carbon fiber 104, and 10 wt % of the white powder 106. Such an example of the nib 100 having 10 wt % of the white powder 106 may be light grey in color.

In an example, the white powder 106 may be nylon. Nylon is a thermoplastic material that can be processed into shapes, such as nibs of styluses. In an example, the nylon can be varied in a range of 5 wt % to 10 wt % to control the color of the nib 100 of the stylus from dark grey to light grey. Although nylon is used as the white powder 106 in the nib 100, material other than nylon can be used as white powder which may control the grey coloring of the nib 100 of the stylus.

In an example, the composition of the nib 100 may include the polyamide 102, the carbon fiber 104, and the white powder 106. It may be noted that, in an example, the nib 100 is made of 75 wt % of the polyamide 102, 20 wt % of the carbon fiber 104, and 5 wt % of the white powder 106. Such an example of the nib 100 having 5 wt % of the white powder 106 may be dark grey in color.

Further, in an example, the nib 100 is through-and-through made of one of the polycarbonate 102 and the polyamide 102, the carbon fiber 104 and the white powder 106. Due to such a through-and-through make of the nib 100, the nib 100 remains grey even after abrading when used for a period of time. In an example, the nib 100 may have a frusto-conical shape. The frusto-conical shape is a shape of a frustum of a cone. Such a frusto-conical shape of the nib 100 may be obtained by molding of one of the polycarbonate 102 and the polyamide 102, the carbon fiber 104, and the white powder 106.

In an example, the frusto-conical shape of the nib 100 of the stylus may be hollow. In an example, the frusto-conical shape of the nib 100 of the stylus may be solid. The nib 100 having a solid frusto-conical shape may be chiselled for making the nib 100 sharper or pointier for reuse when the nib 100 abrades during operation of the stylus and becomes blunt. Therefore, the nib 100 of the stylus can be reused and thus prevents replacement of the nib 100 even after abrasion of the nib 100.

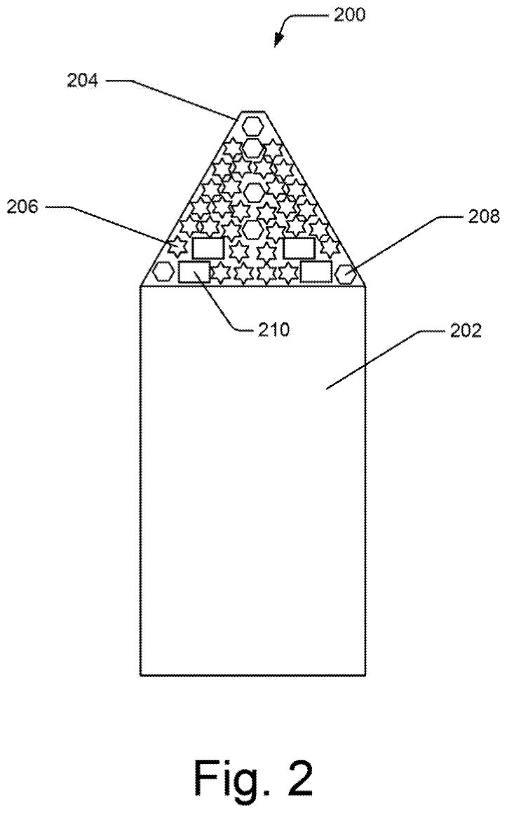

FIG. 2 illustrates a sectional view of a stylus 200, according to an example. A stylus is a pointing device used with touch-sensitive display devices such as smart phones, portable digital assistants, and tablet-style computers. In an example, the stylus 200 may be an active stylus. As shown, the stylus 200 has a longitudinal body 202 and a nib 204 coupled to the longitudinal body 202. The longitudinal body 202 of the stylus 200 may be held by a user (not shown) of the stylus 200 and touched to a touch-sensitive surface of a touch-sensitive display device for providing a user input.

The nib 204 of the stylus 200 is made of a composition including a base material in a range of 70 wt % to 75 wt %. The base material is indicated by stars in FIG. 2 and referenced as 206. The base material is a major material used in the composition and is compatible with other materials to be used in the composition of the nib 204. The base material 206 is selected such that the nib 204 of the stylus 200 becomes soft for reshaping the nib 204 of the stylus 200. In an example, the base material 206 is a polyamide. In an example, the base material 206 is a polycarbonate.

The composition of the nib 204 further includes a conductive material in a range of 15 wt % to 20 wt %. The conductive material is indicated by hexagons in FIG. 2 and referenced as 208. The conductive material 208 is to impart touch sensitivity to the stylus 200 with respect to the touch-sensitive display device. The conductive material 208 is compatible with the base material 206 of the nib 204 and makes the nib 204 conductive while being soft. In an example, the conductive material 208 is carbon fiber.

Further, the composition of the nib 204 includes a grey color controlling material in a range of 5 wt % to 10 wt %. The grey color controlling material is indicated by rectangles in FIG. 2 and referenced as 210. The grey color controlling material 210 controls a grey shade of the nib 204 of the stylus 200. Variation in the wt % of the grey color controlling material 210 may vary the grey coloring of the nib 204 from light grey to dark grey. In an example, the grey color controlling material 210 is a white powder. In an example, the white powder is nylon.

Such composition of the nib 204 of the stylus 200 having the base material 206, the conductive material 208 and the grey color controlling material 210 ensures that the stylus 200 has a touch-sensitive performance with respect to the touch-sensitive display device while providing grey shade options of the nib 204.

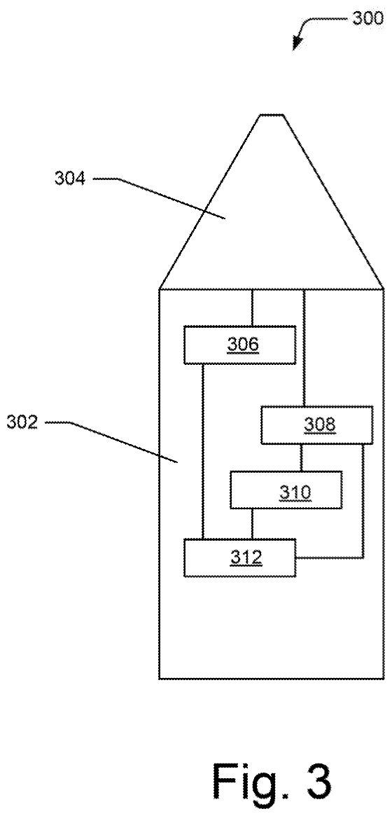

FIG. 3 illustrates a schematic view of a stylus 300, according to an example. As shown, the active stylus 300 includes a longitudinal body 302 and a nib 304. The longitudinal body 302 may be similar to the longitudinal body 202 of the stylus 200 of FIG. 2, and the nib 304 may be similar to the nib 204 of the stylus 200 of FIG. 2 or the nib 100 of FIG. 1. In an example, the nib 304 has a hollow frusto-conical shape or a solid frusto-conical shape. With the solid frusto-conical shape, the nib 304 can be chiselled for reuse, thereby preventing the replacement of the stylus 300 due to deterioration of the nib after a period of usage.

In an example, the stylus 300 may include a drive circuitry 306, a sense circuitry 308, a processor 310, and a power source 312. The drive circuitry 306 is connected to the nib 304 of the stylus 300. Further, the sense circuitry 308 is connected to the nib 304 of the stylus 300 and the processor 310. The drive circuitry 306, the sense circuitry 308 and the processor 310 may be powered by the power source 312, such as a battery, provided within the stylus 300. In an example, the stylus 300 may be powered by an external power source (not shown).

The nib 304 of the stylus 300, having a conductive material, acts as an electrode. The drive circuitry 306 may generate a stimulus signal which can be actively transmitted from the nib 304, i.e., the electrode, to a touch-sensitive display device on which the stylus 300 is touched. The touch-sensitive display device can detect the stimulus signal from the stylus 300 and determines a location of the stylus 300 on a touch-sensitive surface of the touch-sensitive display device. Based on the detected location of the stylus 300, the touch-sensitive display device generates a signal. The signal generated by the touch-sensitive display device may be received at the electrode, i.e., the nib 304 of the stylus 300. The sense circuitry 308 may sense the signal received at the electrode. The signal sensed by the sense circuitry 308 may be processed by the processor 310 of the stylus 300 and/or transmitted back to the touch-sensitive display device for further processing.

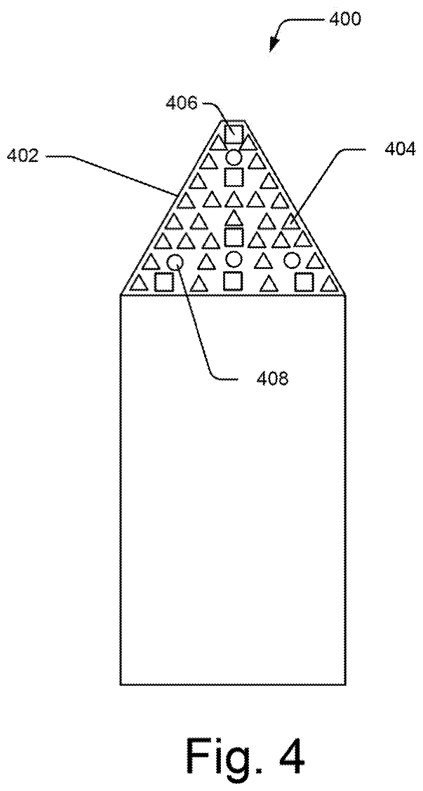

FIG. 4 illustrates a schematic view of a stylus 400, according to an example. As shown, the stylus 400 may include a nib 402. The nib 402 may be similar to the nib 100 of FIG. 1. The nib 402 is through-and-through made of one of a polycarbonate and a polyamide, carbon fiber, and a white powder. The polycarbonate or the polyamide in the nib 400 is indicated by triangles in FIG. 4 and referenced as 404. The reference numeral 404 may be interchangeably used to refer to the polycarbonate or the polyamide. The polycarbonate 404 or the polyamide 404 in the nib 402 is in a range of 70 wt % to 75 wt %. The polycarbonate 404 or the polyamide 404 makes the nib 402 soft, therefore a touch-sensitive surface of a touch-sensitive display device does not abrade when the stylus 400 is touched on it.

Further, the carbon fiber is indicated by squares in FIG. 4 and referenced as 406. The carbon fiber 406 in the nib 402 is in a range of 15 wt % to 20 wt %. The carbon fiber 406 makes the nib 402 conductive without compromising softness of the nib 402 of the stylus 400. Yet further, the white powder is indicated by circles in FIG. 4 and referenced as 408. The white powder 408 in the nib 402 is in a range of 5 wt % to 10 wt %. The white powder 408 enables grey color control of the nib 402 of the stylus 400 from light grey to dark grey depending on the wt % of the white powder 408 in the nib 402. In an example, the white powder 408 is nylon.

Although examples for the present disclosure have been described in language specific to structural features and/or methods, it is to be understood that the appended claims are not limited to the specific features or methods described herein. Rather, the specific features and methods are disclosed and explained as examples of the present disclosure.

We claim:

1. A nib for a stylus, the nib being made of:
one of a polyamide and a polycarbonate in a range of 70 weight percentage (wt %) to 75 wt %;
carbon fiber in a range of 15 wt % to 20 wt %; and
a white powder in a range of 5 wt % to 10 wt %.

2. The nib as claimed in claim 1, wherein the white powder is nylon.

3. The nib as claimed in claim 1, wherein the nib has a hollow frusto-conical shape.

4. The nib as claimed in claim 1, wherein the nib has a solid frusto-conical shape.

5. The nib as claimed in claim 1, wherein the polyamide is 75 wt %, the carbon fiber is 20 wt %, and the white powder is 5 wt %.

6. The nib as claimed in claim 1, wherein the polycarbonate is 70 wt %, the carbon fiber is 20 wt %, and the white powder is 10 wt %.

7. A stylus comprising:
a longitudinal body; and
a nib coupled to the longitudinal body, the nib being made of:
a base material in a range of 70 weight percentage (wt %) to 75 wt %;
a conductive material in a range of 15 wt % to 20 wt %; and
a grey color controlling material in a range of 5 wt % to 10 wt %.

8. The stylus as claimed in claim 7, wherein the base material is a polyamide.

9. The stylus as claimed in claim 7, wherein the base material is a polycarbonate.

10. The stylus as claimed in claim 7, wherein the conductive material is carbon fiber.

11. The stylus as claimed in claim 7, wherein the grey color controlling material is a white powder.

12. The stylus as claimed in claim 11, wherein the white powder is nylon.

13. The stylus as claimed in claim 7, wherein the nib has one of a hollow frusto-conical shape and a solid frusto-conical shape.

14. A stylus comprising:
a nib, the nib being through-and-through made of:
one of a polyamide and a polycarbonate in a range of 70 weight percentage (wt %) to 75 wt %;
carbon fiber in a range of 15 wt % to 20 wt %; and
a white powder in a range of 5 wt % to 10 wt %.

15. The stylus as claimed in claim 14, wherein the white powder is nylon.
